(19) United States
(12) Patent Application Publication
(10) Pub. No.: US 2004/0050666 A1
(43) Pub. Date: Mar. 18, 2004

(54) Conveying and removing of rod-articles in the tobacco processing industry

(75) Inventors: Torsten Morke, Dissau (DE); Berthold Maiwald, Schwarzenbek (DE); Heidi Stolz, Oststeinbek (DE)

Correspondence Address: VENABLE, BAETJER, HOWARD AND CIVILETTI, LLP, P.O. BOX 34385, WASHINGTON, DC, 20043-9998, US

(73) Assignee: HAUNI Maschinenbau Aktiengesellschaft, Hamburg (DE)

(21) Appl. No.: 10/660,765

(22) Filed: Sep. 12, 2003

(30) Foreign Application Priority Data
Sep. 13, 2002 (EP) 02 020 640.5

(51) Int. Cl. B65G 29/00

(52) U.S. Cl. 198/471.1; 198/438; 198/441

(57) ABSTRACT

A method and apparatus for conveying rod-shaped articles in the tobacco-processing industry, wherein a holding vacuum is used to hold the articles on a conveying drum. For removal of an article, in a transfer region to a removal drum, the holding vacuum at the conveying drum is stopped for the removal and a holding vacuum is applied to the removal drum.

### CROSS-REFERENCE TO RELATED APPLICATION

This application claims the priority of European Patent Application Serial No. 02 020 640.5, filed on Sep. 13, 2002, the subject matter of which, together with each and every U.S. and foreign Patent and Patent Application mentioned herein, is incorporated herein by reference.

### BACKGROUND OF THE INVENTION

The invention relates to a method for conveying rod-shaped articles in the tobacco-processing industry, in particular cigarettes, wherein the articles are held with a holding vacuum on a conveying drum and wherein an article to be removed is transferred in a transfer region to a removal drum. The invention furthermore relates to an apparatus for conveying rod-shaped articles in the tobacco-processing industry, in particular cigarettes, comprising at least one conveying drum and one removal drum which can respectively be admitted with a vacuum for holding the articles.

The invention also relates to a machine in the tobacco-processing industry, in particular a filter-attachment machine.

In connection with the present case, rod-shaped articles in the tobacco-processing industry are understood to be objects held with suction air in a single-layer row on conveyors, i.e. conveying drums in cigarette-production machines, which are conveyed by these conveyors. Articles of this type are filter cigarettes, cigars, cigarillos, filter rods etc. If in the following reference is made only to cigarettes for the sake of simplicity, such reference applies equally to other articles of the aforementioned type, which are to be conveyed.

In a cigarette production machine, suction air is used to hold cigarettes in a single-layer row and transverse to their axial orientation on conveying drums, primarily drums on cigarette production machines and/or filter-attachment machines. For this, the circumferential surface of the conveying drums is provided with suction air openings that are connected to a vacuum source. The transfer of cigarettes from a first conveyor to the following conveyor as a rule occurs by interrupting the holding air supplied to the respectively first, releasing conveyor in the transition region while the holding air for the respectively second, receiving conveyor is turned on. For a normal transfer from one conveying drum to the following drum, fixed control sections are arranged on the inside of the circumferential area of the conveyor that forms the transfer region and are used to interrupt the holding air. These control sections cover the suction air openings in this area of the conveyor, thus cutting off the vacuum pressure.

Research Disclosure 17011 of June 1978, describes an apparatus for carefully separating out rod-shaped articles in the tobacco-processing industry, wherein a controllable compressed-air supply is assigned to a conveyor in a transfer region. An article to be separated out can thus be transferred with the aid of a compressed-air surge from a receptacle in the conveying conveyor to a receptacle in the removing conveyor. The first conveyor is provided with a reducing valve in the area of transition, which is designed for reducing the holding vacuum, so that a cigarette is blown out of the releasing drum with compressed air and counter to the reduced vacuum pressure in the holding bores.

U.S. Pat. No. 4,452,255, co-owned by the Assignee of the present application, discloses the transfer of cigarettes from one drum to the following drum, wherein the holding vacuum on the first drum is turned off for the cigarette transfer. If a defective cigarette or a sample cigarette is to remain on the first drum, compressed air is blown from the receiving trough to the releasing trough and the holding vacuum in the releasing trough is thus reduced. At the same time, compressed air is supplied by the same compressed-air source to an injector, which creates a vacuum pressure in the releasing trough of the first drum, so that the cigarette remains inside the releasing trough during the continued conveying.

The transfer of cigarettes from a trough conveyor to a sample removal drum is described in European Patent EP-B-0 584 774. In that case, the vacuum pressure at the receiving trough in the sample removal drum is higher than the vacuum pressure at the releasing trough in the drum conveyor.

The disadvantage when removing a cigarette from the production stream is that compressed air is blown against the cigarette to be removed, so that the cigarette is accelerated by the compressed air and flies from the releasing trough to land in the receiving trough of the removal drum. This type of removal is hard to adjust and can be adjusted only for a predetermined drum speed. In addition, the cigarette is subjected to heavy mechanical stress and, in some circumstances, is deformed, so that it will not pass the subsequent quality control.

### SUMMARY OF THE INVENTION

It is an object of the present invention to make possible a careful transfer during the removal of cigarettes from the production flow. The above and other objects are achieved according to the invention with a method for conveying rod-shaped articles in the tobacco-processing industry, comprising: holding the articles on a conveying drum with the aid of a holding vacuum; transferring the respective articles in a transfer region from the conveying drum to a removal drum, including stopping the holding vacuum at the conveying drum for removal of the article from the conveying drum and supplying a holding vacuum to the removal drum.

The invention is based on the idea that the holding vacuum at the conveying drum is compensated during the transfer of a cigarette to a removal drum, thus permitting a careful cigarette removal from the running production, i.e. as a sample. In an exemplary embodiment, at the transfer point and/or in the transfer region, suction air is supplied to the respective receiving trough for a cigarette. For the removal of a cigarette sample, the holding vacuum that still exists is compensated, so that the cigarette is no longer held inside the receiving trough.

According to one modification of the invention, the holding vacuum at the removal drum is stopped if no object is removed, so that the cigarettes remain on the conveying drum. The careful removal of a cigarette is possible if a holding vacuum is applied to the receiving trough in the removal drum and the holding vacuum compensation is simultaneously turned off. On the whole, this permits a careful transfer of cigarettes to a removal drum. For example, a holding vacuum is applied to the removal drum during normal operations when no cigarette is removed, but this holding vacuum is compensated and/or will be compensated.

The holding vacuum to the removal drum and the conveying drum is preferably compensated with the aid of compressed air, in particular a pressure surge.

According to one advantageous embodiment of the invention, the compressed air is supplied either to the removal drum or the conveying drum. As a result of the optional compensation of the vacuum that is applied to the drums, the supplied holding vacuum can respectively be canceled depending on the operating mode, meaning the removal and/or non-removal of cigarettes. As a result, only one compressed-air source is required which is connected to the removal drum or the conveying drum, depending on the operating mode.

In addition, the articles are admitted with a holding vacuum via suction bores in the conveying drum or via suction bores in the removal drum.

It is particularly advantageous if the holding vacuum applied to a single receptacle for an article is stopped. As a result, compressed air is always supplied for exactly one transfer operation. The cigarette in the transfer region is either held on the conveying drum or is transferred to the removal drum.

The object is furthermore solved for an apparatus of the aforementioned type in that for the removal of an article from the conveying drum with the aid of the removal drum, means are provided for stopping the holding vacuum at the conveying drum.

According to a preferred modification of the invention, the holding vacuum at the removal drum can be stopped if no articles are removed.

In particular, the holding vacuum can be stopped with the aid of compressed air, especially a compressed air surge.

The compressed air furthermore can be supplied either to the removal drum or to the conveying drum.

To hold and transport cigarettes and the like, the conveying drum and/or the removal drum is provided with suction bores for applying the holding vacuum.

It is furthermore possible with the apparatus according to the invention to stop the holding vacuum for a single article receptacle in the conveying drum or the removal drum.

A compressed-air source is provided for compensating the holding vacuum applied to the drums.

In addition, a valve is provided for the compressed-air source for optionally connecting the compressed-air source either to the conveying drum or the removal drum.

According to a further aspect of the invention, there is provided a filter-attachment machine tobacco processing industry which is designed according to the invention with an apparatus as described in the above.

### BRIEF DESCRIPTION OF THE DRAWINGS

The invention is described with the aid of an exemplary embodiment shown in the drawings and without restricting the general inventive idea, wherein the drawings are expressly referred to for all details not explained further in the text.

FIG. 1 shows a cross-sectional detail of a drum arrangement for the situation in which no articles are removed.

FIG. 2 shows a cross-sectional detail of a drum arrangement for the situation in which articles are removed.

### DETAILED DESCRIPTION OF THE INVENTION

Identical elements are provided with the same reference numbers in the following drawings and will not be introduced again.

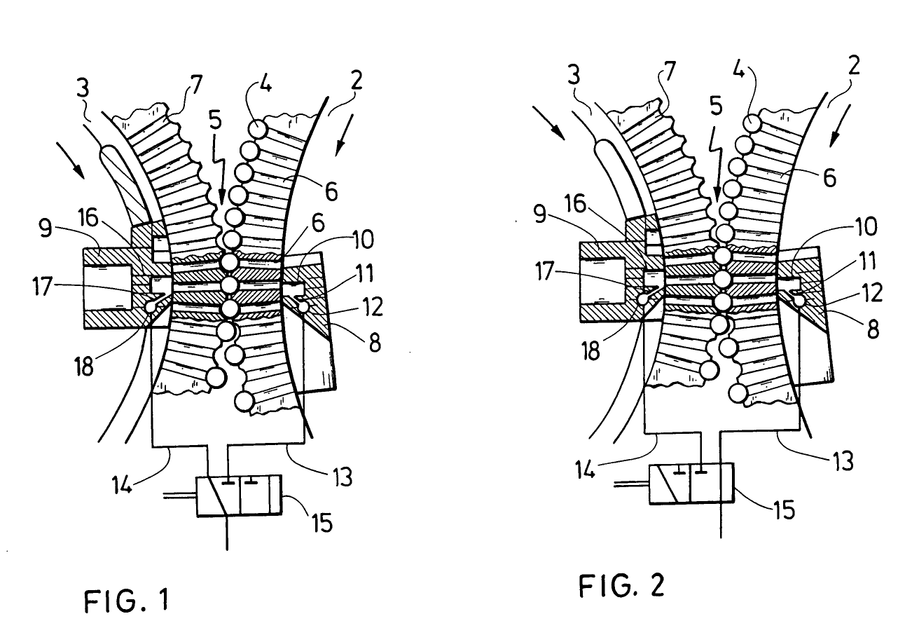

FIGS. 1 and 2 respectively show cross-sectional details of the same drum arrangement, consisting of a conveying drum 2 and a removal drum 3.

The conveying drum 2 is provided with suction bores 6 on its outer circumferential surface, to which suction air is applied so that the cigarettes 4 rest inside the receiving troughs of the conveying drum 2 and are held therein. The conveying drum 2 moves the cigarettes 4 to a transition region 5 where respectively one cigarette 4 is removed with the aid of the removal drum 3. The removal drum 3 is also provided with receiving troughs on its circumferential surface, to which suction air can be applied via suction bores 7.

A portion of a control member 8 is arranged inside the conveying drum 2, in the transition region 5. The locally fixed control member 8 has a bore 10 to which suction air is continuously applied. The bore 10 is furthermore connected via a connecting piece 11 to a channel 12, which can be connected via a line 13 and a reversing valve 15 to a compressed-air source (not shown herein).

A section of a control member 9 is arranged inside the removal drum 3. The control member 9 additionally contains a bore 16 in the transition region 5, which is connected via a connecting piece 17 to a channel 18. The channel 18 can be supplied via a line 14 with compressed air and can be connected to a compressed air source by switching the valve 15 accordingly (FIG. 1).

FIG. 1 shows the case where no cigarette 4 is removed from the conveying drum 2 while FIG. 2 shows the case where a cigarette is removed.

Suction air is applied to bores 10 and/or 16 of the drums 2 and/or 3 during the operation, wherein the holding vacuum at the bore 16 is compensated with compressed air from the compressed air source via the valve 15, the line 14, the channel 18 and the connecting piece 17 if no article is removed. In that case, the cigarettes 4 remain on the conveying drum 2 (FIG. 1).

The valve 15 is reversed for removing a random sample, so that the compressed air supplied to the bore 10 can compensate the holding vacuum. The reversal of valve 15 causes a pressure surge, which compensates the holding vacuum at the bore 10 and the cigarette 4 is no longer held against the drum 2. At the same time, the holding vacuum compensation at the bore 16 of drum 3 is stopped and/or turned off, so that the cigarette 4 is transferred to the removal drum 3. Following the transfer, the valve 15 is switched back to its starting position (FIG. 1).

The subject matter of the invention results in a careful transfer and handling of the cigarettes since the cigarettes are removed carefully and are not pulled counter to the vacuum pressure resistance from the troughs of the conveying drum, which results in deformation. In addition, it is not necessary to switch on a vacuum for transferring the cigarette.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A method for conveying rod-shaped articles in the tobacco-processing industry, comprising:
holding the articles on a conveying drum with the aid of a holding vacuum;
transferring the respective articles in a transfer region from the conveying drum to a removal drum, including stopping the holding vacuum at the conveying drum for removal of the article from the conveying drum and supplying a holding vacuum to the removal drum.

2. The method according to claim 1, further including stopping the holding vacuum at the removal drum if no articles are to be removed.

3. The method according to claim 2, wherein the stopping steps are effected by stopping the respective holding vacuum with the aid of pressure surge.

4. The method according to claim 3, further including supplying compressed air to one of the removal drum and the conveying drum to create the pressure surge.

5. The method according to claim 1, wherein the holding step includes supplying the holding vacuum to the articles via suction bores in the conveying drum and and the supplying step includes supplying the vacuum to the removal drum via suction bores in the removal drum.

6. The method according to claim 1, wherein the stopping step includes stopping the holding vacuum supplied to a single receiving trough for an article in the conveying drum.

7. The method according to claim 2, wherein the step of stopping the holding vacuum at the removal drum includes stopping the holding vacuum supplied to a single receiving trough for an article

8. An apparatus for conveying rod-shaped articles in the tobacco-processing industry, comprising:
a conveying drum adapted to be supplied with a vacuum for holding articles;
a removal drum adapted to be supplied with a holding vacuum for holding articles; and
first means for stopping the holding vacuum at the conveying drum while an article is removed from the conveying drum with the aid of the removal drum.

9. The apparatus according to claim 8, including second means for stopping the holding vacuum at the removal drum if no articles are removed from the conveying drum.

10. The apparatus according to claim 9, wherein at least one of the first and second stopping means includes means for stopping the respective holding vacuum with the aid of compressed air.

11. The apparatus according to claim 8, wherein at least one of the conveying drum and the removal drum include suction bores.

12. The apparatus according to claim 8, wherein the conveying drum and the removal drum each have troughs for holding the articles, and the apparatus further includes means for stopping the holding vacuum to a single article trough in one of the conveying drum and the removal drum.

13. The apparatus according to claim 10, further comprising a compressed air source communicating with the means for stopping.

14. The apparatus according to claim 13, further including a valve coupled between the compressed-air source and the means for stopping.

15. A filter attachment machine in the tobacco-processing industry, comprising an apparatus according to claim 8.
